(19) United States
(12) Patent Application Publication
(10) Pub. No.: US 2012/0088709 A1
(43) Pub. Date: Apr. 12, 2012

(54) DETERGENT FOR USE IN APPLIANCES

(75) Inventors: Arnd Kessler, Monheim am Rhein (DE); Thorsten Bastigkeit, Wuppertal (DE); Christian Nitsch, Dusseldorf (DE)

(73) Assignee: Henkel AG & Co., KGaA, Dusseldorf (DE)

(21) Appl. No.: 13/329,399

(22) Filed: Dec. 19, 2011

Related U.S. Application Data
(63) Continuation of application No. PCT/EP2010/058902, filed on Jun. 23, 2010.

(30) Foreign Application Priority Data
Jun. 24, 2009 (DE) 10 2009 027 162.7

(51) Int. Cl. C11D 17/00; B08B 3/08; D06L 1/20

(52) U.S. Cl. 510/223; 510/221; 510/337; 510/293; 8/137; 134/25.2

(57) ABSTRACT

Disclosed are liquid alkaline detergent preparations that are to be dispensed automatically when washing dishes in a dishwasher, comprising: a) 15 to 60 percent by weight of builder; b) 30 to 80 percent by weight of water; and c) less than 5 percent by weight of surfactant. Because of their thermal stability, the detergent preparations are particularly suitable for carrying out automatic dispensing processes when washing dishes in a dishwasher and washing fabrics in a washing machine. Furthermore, the detergent preparations are characterized by significantly improved cleaning power compared with conventional methods.

### CROSS-REFERENCE TO RELATED APPLICATIONS

This application is a continuation of PCT Application Serial No. PCT/EP2010/058902, filed on Jun. 23, 2010, which claims priority under 35 U.S.C. §119 to 10 2009 027 162.7 (DE), filed on Jun. 24, 2009. The disclosures PCT/EP2010/058902 and DE 10 2009 027 162.7 are hereby incorporated by reference in their entirety.

### FIELD OF THE INVENTION

The present application describes builder-containing automatic cleaning agents, in particular dishwashing agents and textile washing agents, automatic cleaning methods using said cleaning agents, and the use of said cleaning agents in automatic cleaning methods in which sub-quantities of an automatic cleaning agent are dispensed out of a reservoir container present in the interior of the automatic dishwasher and/or textile washing machine, in the course of multiple successive cleaning cycles, into the interior of the automatic dishwasher and/or textile washing machine

### BACKGROUND OF THE INVENTION

The forms in which washing and cleaning agents are packaged and presented are constantly subject to new changes. Emphasis has for some time been placed principally on convenient dispensing of washing and cleaning agents, and on simplification of the working steps necessary for carrying out a washing or cleaning method.

In this connection, apparatuses for multiple dispensing of washing and cleaning agents have very recently attracted attention from product developers. With regard to these apparatuses, a distinction can be made between on the one hand dispensing containers integrated into the automatic dishwasher or textile washing machine, and on the other hand apparatuses independent of the automatic dishwasher or textile washing machine. By means of these apparatuses, which contain several times the quantity of cleaning agent required to carry out a cleaning method, washing- or cleaning-agent portions are automatically or semi-automatically dispensed into the interior of the cleaning appliance in the course of multiple successive cleaning processes. For the consumer, the need for repeated manual dispensing of the washing and cleaning agents is eliminated. Examples of such apparatuses are described in European patent application EP 1 759 624 A2 (Reckitt Benckiser) or in German patent application DE 10 2005 062 479 A1 (BSH Bosch and Siemens Hausgeräte GmbH).

Regardless of the exact deign of the dispensing apparatuses used in the interior of automatic dishwashers or textile washing machines, the washing or cleaning agents contained in these apparatuses for multiple dispensing are exposed over a long period of time, in particular, to changing temperatures, these temperatures being equivalent, to a first approximation, to the water temperatures used to carry out the washing or cleaning method. These temperatures can be equal to up to 95° C., although the temperatures reached in the sector of automatic tableware cleaning are only between 50 and 75° C. An apparatus provided for multiple dispensing and containing washing or cleaning agent is therefore, in the course of multiple washing or cleaning methods, repeatedly heated to temperatures well above the temperatures usual for transport and for storage; temperature-sensitive active substances are subjected to the same experience, and sedimentation processes in cleaning-agent dispersions can be accelerated.

The methods hitherto discovered and described in the existing art for stabilizing cleaning-agent preparations have given only limited consideration to the problem of repeated temperature stress, for example as it may occur in the apparatuses described previously for multiple dispensing of washing or cleaning agents. The methods known so far are of only limited suitability for avoiding loss of activity and for avoiding segregation in liquid cleaning agents. This applies in particular to highly concentrated liquid cleaning agent compositions having low solvent concentration.

Therefore, it remains desirable to find highly concentrated liquid preparations having washing or cleaning activity that are stable against phase separation and activity loss when subjected to multiple temperature fluctuations (10 to 75° C.). It is also desirable to develop preparations capable of storage, without significant activity loss, in a reservoir apparatus present in the interior of the automatic dishwasher or textile washing machine. Furthermore, other desirable features and characteristics of the present invention will become apparent from the subsequent detailed description of the invention and the appended claims, taken in conjunction with the background of the invention.

### BRIEF SUMMARY OF THE INVENTION

It has now been surprisingly found that a liquid alkaline cleaning-agent preparation A for automatic dispensing in automatic dishwashing, comprising: (a) 15 to 60 wt % builder; (b) 30 to 80 wt % water; and, (c) less than 5 wt % surfactant, is stable against phase separation and activity loss in the presence of multiple temperature fluctuations (10 to 75° C.).

In an exemplary embodiment of the present invention, a liquid alkaline cleaning-agent preparation A is provided for automatic dispensing in automatic dishwashing, with said preparation comprising:

(a) 15 to 60 wt % builder;
(b) 30 to 80 wt % water; and
(c) less than 5 wt % surfactant,
wherein cleaning-agent preparation A comprises a quantity of cleaning agent sufficient for carrying out an automatic dishwashing method at least twice, by preference at least four times, and in particular at least eight times.

In another embodiment of the present invention, a liquid alkaline cleaning-agent preparation A is provided for automatic dispensing in automatic textile washing, with said preparation comprising:

(a) 15 to 60 wt % builder;
(b) 30 to 80 wt % water; and
(c) less than 5 wt % surfactant,
wherein the cleaning-agent preparation A comprises a quantity of cleaning agent sufficient for carrying out an automatic textile washing method at least twice, by preference at least four times, and in particular at least eight times.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present application describes and claims subject matter of this Application is liquid (20° C.) cleaning-agent preparations. The liquid cleaning-agent preparations A are water-containing. Particularly preferred liquid cleaning-agent preparations A are characterized in that the cleaning-agent preparation A contains, based on its total weight, between 35 and 75 wt % and in particular between 40 and 70 wt % water. The water contents realized are preferably above 45 wt %, particularly preferably above 50 wt %, and in particular above 55 wt %. The upper limit of the water content is by preference 68 wt % and in particular 65 wt %.

The term “water content” encompasses the total quantity of water contained in the agents according to the present invention, which is made up of the free water contained in the agents as well as the water incorporated into the cleaning-agent preparations in bound form via the having washing and cleaning activity. The water content is to be determined, for example, as drying loss or by the Karl Fischer method.

The cleaning-agent preparations according to the present invention are alkaline. “Alkaline” cleaning-agent preparations refers to those preparations that have a pH (10% solution in water, 20° C.) above 8, by preference between 8.5 and 12.5, and in particular between 9.0 and 12.0.

Stabilization of cleaning-agent preparations according to the present invention is accomplished, according to the present invention, by lowering the surfactant content of the liquid preparations that contain high levels of builder. Preferred cleaning-agent preparations according to the present invention are characterized in that the cleaning-agent preparation A contains, based on its total weight, less than 4.0 wt %, by preference less than 3.0 wt %, and in particular less than 1.0 wt % surfactant. Particularly preferred preparations have a surfactant upper limit of 0.5 wt %, in particular 0.2 wt %. Very particularly preferred cleaning-agent preparations A according to the present invention are surfactant-free.

The cleaning-agent preparations A according to the present invention contain, alongside water, 15 to 60 wt % builder as a further essential constituent.

As stipulated according to the present Application, the group of the builders includes the organic complexing agents as well as the alkali carriers and the anionic polymers having cleaning activity. The high builder content (from 15 to 60 wt %) of cleaning-agent preparations according to the present invention is distributed over these three groups of builders.

The group of the organic complexing agents includes in particular polycarboxylates/polycarboxylic acids, polymeric carboxylates, aspartic acid, polyacetals, dextrins, and further organic cobuilders such as the phosphonates. These substance classes are described below.

Usable organic complexing agents are, for example, the polycarboxylic acids usable in the form of the free acid and/or their sodium salts, “polycarboxylic acids” being understood as those carboxylic acids that carry more than one acid function. These are, for example, citric acid, adipic acid, succinic acid, ethylenediaminodisuccinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. The free acids typically also possess, in addition to their builder effect, the property of an acidifying component, and thus also serve to establish a lower and milder pH for washing or cleaning agents. Worthy of mention in this context are, in particular, citric acid, succinic acid, glutaric acid, adipic acid, gluconic acid, and any mixtures thereof.

Also to be mentioned as further preferred builder substances are polymeric aminodicarboxylic acids, salts thereof, or precursor substances thereof. Polyaspartic acids and/or salts thereof are particularly preferred.

Further suitable organic complexing agents are polyacetals, which can be obtained by reacting dialdehydes with polyolcarboxylic acids that comprise 5 to 7 carbon atoms and at least three hydroxyl groups. Preferred polyacetals are obtained from dialdehydes such as glyoxal, glutaraldehyde, terephthalaldehyde, and mixtures thereof, and from polyolcarboxylic acids such as gluconic acid and/or glucoheptonic acid.

Further suitable organic complexing agents are dextrins, for example oligomers and/or polymers of carbohydrates, which can be obtained by partial hydrolysis of starches. The hydrolysis can be carried out in accordance with usual, e.g. acid- or enzyme-catalyzed, methods. These are by preference hydrolysis products having average molar weights in the range from 400 to 500,000 g/mol. A polysaccharide having a dextrose equivalent (DE) in the range from 0.5 to 40, in particular from 2 to 30, is preferred, DE being a common indicator of the reducing effect of a polysaccharide as compared with dextrose, which possesses a DE of 100. Both maltodextrins with DE between 3 and 20 and dry glucose syrups having a DE between 20 and 37, as well as so-called yellow dextrins and white dextrins having higher molar weights in the range from 2000 to 30,000 g/mol, are usable.

The oxidized derivatives of such dextrins are their reaction products with oxidizing agents that are capable of oxidizing at least one alcohol function of the saccharide ring to the carboxylic acid function.

Oxydisuccinates and other derivatives of disuccinates, by preference ethylenediamine disuccinate, are also additional suitable co-builders. Ethylenediamine-N,N′-disuccinate (EDDS) is used here, preferably in the form of its sodium or magnesium salts. Also preferred in this context are glycerol disuccinates and glycerol trisuccinates. Suitable utilization quantities are from 3 to 15 wt %.

With particular preference, the automatic dishwashing agents and textile washing agents according to the present invention contain methylglycinediacetic acid or a salt of methylglycinediacetic acid.

Other usable organic complexing agents are, for example, acetylated hydroxycarboxylic acids and/or salts thereof, which can optionally also be present in lactone form and which contain at least 4 carbon atoms and at least one hydroxy group, as well as a maximum of two acid groups.

Preferred cleaning-agent preparations A according to the present invention are characterized in that the cleaning-agent preparation A contains, based on its total weight, 17 to 50 wt %, by preference 20 to 45 wt %, and in particular 23 to 40 wt % builder(s) from the group of the organic complexing agents. Concentrations of organic complexing agents preferably above 25 wt %, particularly preferably above 30 wt %, are realized. The upper limit of the organic complexing agent content is by preference 55 wt % and in particular 35 wt %.

Particularly preferred automatic dishwashing agents and automatic textile washing agents according to the present invention contain citrate as one of their essential organic complexing agents. The term “citrate” here includes citric acid and salts thereof, in particular alkali-metal salts thereof. With regard to the weight proportion of citrate used in the agents according to the present invention, when the free acid is used it is important to consider the weight proportion of the sodium salt, i.e. to convert from the weight proportion of the free acid to the weight proportion of the sodium salt. Cleaning-agent preparations according to the present invention wherein they contain 2.0 to 50 wt %, by preference 4.0 to 40 wt %, and in particular 5.0 to 30 wt % citrate, are preferred according to the present invention.

A second important organic complexing agent is ethylenediaminedisuccinic acid (EDDS), preferred cleaning-agent preparations A being characterized in that they contain, based on their total weight, 3.0 to 40 wt %, by preference 5.0 to 30 wt %, and in particular 10 to 20 wt % ethylenediaminedisuccinic acid. Concentrations of ethylenediaminedisuccinic acid preferably above 12 wt %, particularly preferably above 15 wt %, and in particular above 20 wt % are realized. The upper limit of the ethylenediaminedisuccinic acid content is by preference 55 wt % and in particular 45 wt %.

Ethylenediaminedisuccinic acid has proven to be particularly effective, in particular in phosphate-free cleaning-agent preparations, in terms of cleaning tea in the context of automatic dishwashing.

The term “ethylenediaminedisuccinic acid” (EDDS) encompasses not only the free acids but also salts thereof, for example sodium or potassium salts thereof. With regard to the weight proportion of ethylenediaminedisuccinic acid used in the agents according to the present invention, when the acid salt is used it is important to consider the weight proportion of the free acid, i.e. to convert from the weight proportion of the salt to the weight proportion of the acid.

Alternatively or as a supplement to citrate and/or EDDS, the automatic dishwashing agents according to the present invention can lastly contain methylglycinediacetic acid (MGDA). Methyglycinediacetic acid can be present in the agents according to the present invention in the form of the free acid, in partly neutralized or completely neutralized form. In a particularly preferred embodiment, methylglycinediacetic acid is present in the form of an alkali-metal salt.

Methylglycinediacetic acid can be replaced, in the automatic dishwashing agents according to the present invention, by other alkylglycinediacetic acids of the general formula MOOC—CHR—N(CH₂COOM)₂ (R═H or C₂₋₁₂ alkyl; M, mutually independently, is H or alkali metal); methylglycinediacetic acid is, however, preferred for cost reasons.

The complexing phosphonates constitute a group of further organic complexing agents used with preference in the cleaning-agent preparations A according to the present invention, this group comprising, in addition to 1-hydroxyethane-1,1-diphosphonic acid, a number of different compounds such as, for example, diethylenetriaminepenta(methylenephosphonic acid) (DTPMP). Hydroxyalkane- and aminoalkanephosphonates are particularly preferred in this Application. Among the hydroxyalkanephosphonates, 1-hydroxyethane-1,1-diphosphonate (HEDP) is of particular importance as a co-builder. It is used by preference as a sodium salt, the disodium salt reacting neutrally and the tetrasodium salt in alkaline fashion (pH 9). Suitable aminoalkanephosphonates are, by preference, ethylenediaminetetramethylenephosphonate (EDTMP), diethylenetriaminepentamethylenephosphonate (DTPMP), as well as higher homologs thereof. They are used by preference in the form of the neutrally reacting sodium salts, e.g. as a hexasodium salt of EDTMP and/or as a hepta- and octasodium salt of DTPMP. Of the class of the phosphonates, HEDP is preferably used as a builder. The aminoalkanephosphonates moreover possess a pronounced ability to bind heavy metals. It may accordingly be preferred, in particular if the agents also contain bleaches, to use aminoalkanephosphonates, in particular DTPMP, or mixtures of the aforesaid phosphonates.

An automatic dishwashing agent that is preferred in the context of this Application contains one or more phosphonate(s) selected from the group consisting of aminotrimethylenephosphonic acid (ATMP) and/or salts thereof, ethylenediaminetetra(methylenephosphonic acid) (EDTMP) and/or salts thereof, diethylenetriaminepenta(methylenephosphonic acid) (DTPMP) and/or salts thereof, 1-hydroxyethane-1,1-diphosphonic acid (HEDP) and/or salts thereof, 2-phosphonobutane-1,2,4-tricarboxylic acid (PBTC) and/or salts thereof, hexamethylenediaminetetra(methylenephosphonic acid) (HDTMP) and/or salts thereof, and nitrilotri(methylenephosphonic acid) (NTMP) and/or salts thereof.

Automatic dishwashing agents that contain 1-hydroxyethane-1,1-diphosphonic acid (HEDP) or diethylenetriaminepenta(methylenephosphonic acid) (DTPMP) as phosphonates are particularly preferred.

The cleaning-agent preparations according to the present invention can of course contain two or more different phosphonates.

The weight proportion of the phosphonates, in terms of the total weight of cleaning-agent preparation A, is by preference 0.5 to 15 wt %, by preference 1.0 to 10 wt %, and in particular 1.5 to 6.0 wt %.

The compositions of some examples of cleaning-agent preparations A according to the present invention may be gathered from the TABLES 1-4 below. In these and subsequent tables, “--” denotes that this particular ingredient is absent from the formula.

TABLE 1
Exemplary Cleaning-Agent Preparations

| Ingredient | Formula | Formula | Formula | Formula | Formula |
|---|---|---|---|---|---|
| (in wt. %) | 1 | 2 | 3 | 4 | 5 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| Phosphonate | 0.5 to 15 | 0.5 to 15 | 1.0 to 10 | 1.0 to 10 | 1.5 to 6.0 |
| Surfactant | <5.0 | <4.0 | <3.0 | <1.0 | — |
| miscel- | to 100 | to 100 | to 100 | to 100 | to 100 |
| laneous | | | | | |

TABLE 2
Exemplary Cleaning-Agent Preparations

| Ingredient | Formula | Formula | Formula | Formula | Formula |
|---|---|---|---|---|---|
| (in wt. %) | 6 | 7 | 8 | 9 | 10 |
| Water | 30 to 80 | 30 to 80 | 35 to 75 | 35 to 75 | 40 to 70 |
| EDDS | 3.0 to 40 | 5.0 to 30 | 5.0 to 30 | 10 to 20 | 10 to 20 |
| Phosphonate | 0.5 to 15 | 0.5 to 15 | 1.0 to 10 | 1.0 to 10 | 1.5 to 6.0 |
| Surfactant | <5.0 | <4.0 | <3.0 | <1.0 | — |
| miscel- | to 100 | to 100 | to 100 | to 100 | to 100 |
| laneous | | | | | |

TABLE 3
Exemplary Cleaning-Agent Preparations

| Ingredient | Formula | Formula | Formula | Formula | Formula |
|---|---|---|---|---|---|
| (in wt. %) | 11 | 12 | 13 | 14 | 15 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| Surfactant | <5.0 | <4.0 | <3.0 | <1.0 | — |
| miscel- | to 100 | to 100 | to 100 | to 100 | to 100 |
| laneous | | | | | |

TABLE 4
Exemplary Cleaning-Agent Preparations

| Ingredient | Formula | Formula | Formula | Formula | Formula |
|---|---|---|---|---|---|
| (in wt. %) | 16 | 17 | 18 | 19 | 20 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| Phosphonate | 0.5 to 15 | 0.5 to 15 | 1.0 to 10 | 1.0 to 10 | 1.5 to 6.0 |
| Surfactant | <5.0 | <4.0 | <3.0 | <1.0 | — |
| miscel- | to 100 | to 100 | to 100 | to 100 | to 100 |
| laneous | | | | | |

A second group of the builders is constituted by the alkali carriers. Included in the group of the alkali carriers are the carbonates and/or hydrogencarbonates, as well as the alkali-metal hydroxides. The group of the carbonates and hydrogencarbonates is combined in the context of this Application using the term “(hydrogen)carbonate.”

Preferred cleaning-agent preparations according to the present invention are characterized in that the cleaning-agent preparation A contains, based on its total weight, 1.0 to 30 wt %, by preference 2.0 to 25 wt %, and in particular 5.0 to 20 wt % builder(s) from the group of the alkali carriers.

It is particularly preferred to use (hydrogen)carbonate(s), by preference alkali (hydrogen)carbonate(s), particularly preferably sodium (hydrogen)carbonate or potassium (hydrogen)carbonate, in quantities from 1.0 to 40 wt %, by preference 2.0 to 30 wt %, and in particular 4.0 to 15 wt %, based on the total weight of the cleaning-agent preparation A.

The compositions of some examples of cleaning-agent preparations A according to the present invention may be gathered from the TABLE 5-9 below.

TABLE 5
Exemplary Cleaning-Agent Preparations

| Ingredient | Formula | Formula | Formula | Formula | Formula |
|---|---|---|---|---|---|
| (in wt. %) | 21 | 22 | 23 | 24 | 25 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| (Hydrogen)- | 1.0 to 40 | 2.0 to 30 | 2.0 to 30 | 4.0 to 15 | 4.0 to 15 |
| carbonate | | | | | |
| Surfactant | <5.0 | <4.0 | <3.0 | <1.0 | — |
| miscel- | to 100 | to 100 | to 100 | to 100 | to 100 |
| laneous | | | | | |

TABLE 6
Exemplary Cleaning-Agent Preparations

| Ingredient | Formula | Formula | Formula | Formula | Formula |
|---|---|---|---|---|---|
| (in wt. %) | 26 | 27 | 28 | 29 | 30 |
| Water | 30 to 80 | 30 to 80 | 35 to 75 | 35 to 75 | 40 to 70 |
| EDDS | 3.0 to 40 | 5.0 to 30 | 5.0 to 30 | 10 to 20 | 10 to 20 |
| (Hydrogen)- | 2.0 to 20 | 2.0 to 20 | 3.0 to 15 | 3.0 to 15 | 4.0 to 12 |
| carbonate | | | | | |
| Surfactant | <5.0 | <4.0 | <3.0 | <1.0 | — |
| miscel- | to 100 | to 100 | to 100 | to 100 | to 100 |
| laneous | | | | | |

TABLE 7
Exemplary Cleaning-Agent Preparations

| Ingredient | Formula | Formula | Formula | Formula | Formula |
|---|---|---|---|---|---|
| (in wt. %) | 31 | 32 | 33 | 34 | 35 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| (Hydrogen)- | 2.0 to 20 | 2.0 to 20 | 3.0 to 15 | 3.0 to 15 | 4.0 to 12 |
| carbonate | | | | | |
| Surfactant | <5.0 | <4.0 | <3.0 | <1.0 | — |
| miscel- | to 100 | to 100 | to 100 | to 100 | to 100 |
| laneous | | | | | |

TABLE 8
Exemplary Cleaning-Agent Preparations

| Ingredient | Formula | Formula | Formula | Formula | Formula |
|---|---|---|---|---|---|
| (in wt. %) | 36 | 37 | 38 | 39 | 40 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| (Hydrogen)- | 2.0 to 20 | 2.0 to 20 | 3.0 to 15 | 3.0 to 15 | 4.0 to 12 |
| carbonate | | | | | |
| Phosphate | — | — | — | — | — |
| Surfactant | <5.0 | <4.0 | <3.0 | <1.0 | — |
| miscel- | to 100 | to 100 | to 100 | to 100 | to 100 |
| laneous | | | | | |

TABLE 9
Exemplary Cleaning-Agent Preparations

| Ingredient | Formula | Formula | Formula | Formula | Formula |
|---|---|---|---|---|---|
| (in wt. %) | 36a | 37a | 38a | 39a | 40a |
| Water | 30 to 80 | 30 to 80 | 35 to 75 | 35 to 75 | 40 to 70 |
| EDDS | 3.0 to 40 | 5.0 to 30 | 5.0 to 30 | 10 to 20 | 10 to 20 |
| (Hydrogen)- | 2.0 to 20 | 2.0 to 20 | 3.0 to 15 | 3.0 to 15 | 4.0 to 12 |
| carbonate | | | | | |
| Phosphate | — | — | — | — | — |
| Surfactant | <5.0 | <4.0 | <3.0 | <1.0 | — |
| miscel- | to 100 | to 100 | to 100 | to 100 | to 100 |
| laneous | | | | | |

Preferred cleaning-agent preparations according to the present invention contain alkali-metal hydroxide(s) in order to increase and/or adjust the alkalinity. The alkali-metal hydroxides are used in the cleaning agents by preference in quantities between 2.0 and 20 wt %, by preference between 3.0 and 15 wt %, and in particular between 4.0 and 12 wt %, based in each case on the total weight of the cleaning agent. With particular preference, the cleaning-agent preparations A according to the present invention contain sodium hydroxide or potassium hydroxide.

The compositions of some examples of cleaning-agent preparations A according to the present invention may be gathered from the TABLES 10-14 below.

TABLE 10
Exemplary Cleaning-Agent Preparations

| Ingredient | Formula | Formula | Formula | Formula | Formula |
|---|---|---|---|---|---|
| (in wt. %) | 41 | 42 | 43 | 44 | 45 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| Alkali | 2.0 to 20 | 2.0 to 20 | 3.0 to 15 | 3.0 to 15 | 4.0 to 12 |
| hydroxide | | | | | |
| Surfactant | <5.0 | <4.0 | <3.0 | <1.0 | — |
| miscel- | to 100 | to 100 | to 100 | to 100 | to 100 |
| laneous | | | | | |

TABLE 11
Exemplary Cleaning-Agent Preparations

| Ingredient | Formula | Formula | Formula | Formula | Formula |
|---|---|---|---|---|---|
| (in wt. %) | 46 | 47 | 48 | 49 | 50 |
| Water | 30 to 80 | 30 to 80 | 35 to 75 | 35 to 75 | 40 to 70 |
| EDDS | 3.0 to 40 | 5.0 to 30 | 5.0 to 30 | 10 to 20 | 10 to 20 |
| Alkali | 2.0 to 20 | 2.0 to 20 | 3.0 to 15 | 3.0 to 15 | 4.0 to 12 |
| hydroxide | | | | | |
| Surfactant | <5.0 | <4.0 | <3.0 | <1.0 | — |
| miscel- | to 100 | to 100 | to 100 | to 100 | to 100 |
| laneous | | | | | |

TABLE 12
Exemplary Cleaning-Agent Preparations

| Ingredient | Formula | Formula | Formula | Formula | Formula |
|---|---|---|---|---|---|
| (in wt. %) | 51 | 52 | 53 | 54 | 55 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| Alkali | 2.0 to 20 | 2.0 to 20 | 3.0 to 15 | 3.0 to 15 | 4.0 to 12 |
| hydroxide | | | | | |
| Surfactant | <5.0 | <4.0 | <3.0 | <1.0 | — |
| miscel- | to 100 | to 100 | to 100 | to 100 | to 100 |
| laneous | | | | | |

TABLE 13
Exemplary Cleaning-Agent Preparations

| Ingredient | Formula | Formula | Formula | Formula | Formula |
|---|---|---|---|---|---|
| (in wt. %) | 56 | 57 | 58 | 59 | 60 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| Alkali | 2.0 to 20 | 2.0 to 20 | 3.0 to 15 | 3.0 to 15 | 4.0 to 12 |
| hydroxide | | | | | |
| Phosphate | — | — | — | — | — |
| Surfactant | <5.0 | <4.0 | <3.0 | <1.0 | — |
| miscel- | to 100 | to 100 | to 100 | to 100 | to 100 |
| laneous | | | | | |

TABLE 14
Exemplary Cleaning-Agent Preparations

| Ingredient | Formula | Formula | Formula | Formula | Formula |
|---|---|---|---|---|---|
| (in wt. %) | 56a | 57a | 58a | 59a | 60a |
| Water | 30 to 80 | 30 to 80 | 35 to 75 | 35 to 75 | 40 to 70 |
| EDDS | 3.0 to 40 | 5.0 to 30 | 5.0 to 30 | 10 to 20 | 10 to 20 |
| Alkali | 2.0 to 20 | 2.0 to 20 | 3.0 to 15 | 3.0 to 15 | 4.0 to 12 |
| hydroxide | | | | | |
| Phosphate | — | — | — | — | — |
| Surfactant | <5.0 | <4.0 | <3.0 | <1.0 | — |
| miscel- | to 100 | to 100 | to 100 | to 100 | to 100 |
| laneous | | | | | |

Cleaning agent preparations according to the present invention contain by preference less than 10 wt %, particularly preferably less than 5 wt %, and in particular less than 2 wt % phosphate.

Phosphate-free cleaning-agent preparations A are very particularly preferred according to the present invention. Also preferred are those cleaning-agent preparations according to the present invention that contain less than 2 wt %, by preference less than 1 wt %, and in particular less than 0.5 wt % silicate. Very particularly preferred automatic dishwashing agents according to the present invention are surfactant-free. Both the lowering of the phosphate content and the lowering of the silicate content have proven to be advantageous for the stability of the automatic dishwashing agents and textile washing agents according to the present invention

The anionic polymers having cleaning activity constitute a third group of the builders contained in the cleaning-agent preparations according to the present invention.

The anionic polymers having cleaning activity can comprise two, three, four, or more different monomer units. The group of these polymers also encompasses in addition to the homo- and copolymeric polycarboxylates, inter alia, the copolymeric polysulfonates, which comprise alongside a monomer from the group of the unsaturated carboxylic acids at least one further monomer from the group of the unsaturated sulfonic acids.

The weight proportion of anionic polymers having cleaning activity in terms of the total weight of cleaning-agent preparation according to the present invention is by preference equal to 1.0 to 30 wt %, by preference 2.0 to 25 wt %, and in particular 5.0 to 20 wt %.

The polymeric polycarboxylates constitute a first group of anionic polymers having cleaning activity. Examples of such polymers are the alkali-metal salts of polyacrylic acid or of polymethacrylic acid, for example those having a relative molecular weight from 500 to 70,000 g/mol.

Suitable anionic polymers are, in particular, polyacrylates that preferably have a molecular weight from 2000 to 20,000 g/mol. Of this group in turn, the short-chain polyacrylates, which have molecular weights from 2000 to 10,000 g/mol and particularly preferably from 3000 to 5000 g/mol, may be preferred because of their superior solubility.

Also suitable are copolymeric polycarboxylates, in particular those of acrylic acid with methacrylic acid and of acrylic acid or methacrylic acid with maleic acid. Copolymers of acrylic acid with maleic acid that contain 50 to 90 wt % acrylic acid and 50 to 10 wt % maleic acid have proven particularly suitable. Their relative molecular weight, based on free acids, is generally 2000 to 70,000 g/mol, by preference 20,000 to 50,000 g/mol, and in particular 30,000 to 40,000 g/mol.

The concentration of (co)polymeric polycarboxylates in preferred automatic dishwashing agents is by preference 0.5 to 20 wt % and in particular 3 to 10 wt %, based in each case on the total weight of the automatic dishwashing agent.

Preferred copolymeric polysulfonates contain, alongside sulfonic acid group-containing monomer(s), at least one monomer from the group of the unsaturated carboxylic acids.

Unsaturated carboxylic acids of the formula R¹(R²)C═C(R³)COOH are used with particular preference as (an) unsaturated carboxylic acids(s), in which formula R¹ to R³, mutually independently, denote —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or denote —COOH or —COOR⁴ where R⁴ is a saturated or unsaturated, straight-chain or branched hydrocarbon residue having 1 to 12 carbon atoms.

Particularly preferred unsaturated carboxylic acids are acrylic acid, methacrylic acid, ethacrylic acid, α-chloroacrylic acid, α-cyanoacrylic acid, crotonic acid, α-phenylacrylic acid, maleic acid, maleic acid anhydride, fumaric acid, itaconic acid, citraconic acid, methylenemalonic acid, sorbic acid, cinnamic acid, or mixtures thereof. The unsaturated dicarboxylic acids are of course also usable.

In the context of the sulfonic acid group-containing monomers, those of the formula, R⁵(R⁶)C═C(R⁷)—X—SO₃H, in which R⁵ to R⁷, mutually independently, denote —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or denote —COOH or —COOR⁴, where R⁴ is a saturated or unsaturated, straight-chain or branched hydrocarbon residue having 1 to 12 carbon atoms, and X denotes an optionally present spacer group that is selected from —(CH₂)ₙ— where n=0 to 4, —COO(CH₂)ₖ— where k=1 to 6, —C(O)—NH—C(CH₃)₂—, and —C(O)—NH—CH(CH₂CH₃)—, are preferred.

Among these monomers, those of the formulas

H₂C═CH—X—SO₃H,

H₂C═C(CH₃)—X—SO₃H,

and

HO₃S—X—(R⁶)C═C(R⁷)—X—SO₃—H,

in which R⁶ and R⁷, mutually independently, are selected from —H, —CH₃, CH₂CH₃, —CH₂CH₂CH₃, —CH(CH₃)₂, and X denotes an optionally present spacer group that is selected from —(CH₂)ₙ— where n=0 to 4, —COO(CH₂)ₖ— where k=1 to 6, —C(O)—NH—C(CH₃)₂—, and —C(O)—NH—CH(CH₂CH₃)—, are preferred.

Particularly preferred sulfonic acid group-containing monomers in this context are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropylacrylate, 3-sulfopropylmethacrylate, sulfomethacrylamide, sulfomethylmethacrylamide, and mixtures of the aforesaid acids or water-soluble salts thereof.

The sulfonic acid groups can be present in the polymers entirely or partly in neutralized form, i.e. the acid hydrogen atom of the sulfonic acid group can, in some or all sulfonic acid groups, be exchanged for metal ions, by preference alkali metal ions, and in particular for sodium ions. The use of partly or entirely neutralized sulfonic acid group-containing copolymers is preferred according to the present invention.

The monomer distribution of the copolymers preferably used according to the present invention is equal, in the context of copolymers that contain only monomers from groups i) (carboxylic acid group-containing monomers) and ii) (sulfonic acid group-containing monomers), by preference in each case to 5 to 95 wt % i) and/or ii), particularly preferably 50 to 90 wt % monomer from group ii) and 10 to 50 wt % monomer from group i), based in each case on the polymer.

The molar weight of the sulfo-copolymers used in preferred fashion according to the present invention can be varied in order to adapt the properties of the polymers to the desired utilization. Preferred automatic dishwashing agents are characterized in that the copolymers have molar weights from 2,000 to 200,000 g-mol⁻¹, by preference from 4,000 to 25,000 g-mol⁻¹, and in particular from 5,000 to 15,000 g-mol⁻¹.

In a further preferred embodiment, the copolymers also encompass, alongside carboxyl group-containing monomers and sulfonic acid group-containing monomers, at least one nonionic, by preference hydrophobic monomer. The use of these hydrophobically modified polymers has made it possible to improve, in particular, the rinsing performance of automatic dishwashing agents according to the present invention.

Preferred automatic dishwashing agents and automatic textile washing agents are those where the automatic dishwashing agent and/or automatic textile washing agent contains, as an anionic copolymer a copolymer, carboxylic acid group-containing monomer(s), sulfonic acid group-containing monomer(s), or nonionic monomer(s).

The nonionic monomers used are by preference monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms.

Particularly preferred nonionic monomers are butene, isobutene, pentene, 3-methylbutene, 2-methylbutene, cyclopentene, hexene, hexene-1,2-methlypentene-1,3-methlypentene-1, cyclohexene, methylcyclopentene, cycloheptene, methylcyclohexene, 2,4,4-trimethylpentene-1,2,4,4-trimethylpentene-2,2,3-dimethylhexene-1,2,4-dimethylhexene-1,2,5-dimethlyhexene-1,3,5-dimethylhexene-1,4,4-dimethylhexane-1, ethylcyclohexyne, 1-octene, α-olefins having 10 or more carbon atoms such as, for example, 1-decene, 1-dodecene, 1-hexadecene, 1-octadecene, and C22-α-olefin, 2-styrene, α-methylstyrene, 3-methylstyrene, 4-propylstryene, 4-cyclohexylstyrene, 4-dodecylstyrene, 2-ethyl-4-benzylstyrene, 1-vinylnaphthalene, 2-vinylnaphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, N-(methyl)acrylamide, acrylic acid 2-ethylhexyl ester, methacrylic acid 2-ethylhexyl ester, N-(2-ethylhexyl)acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester, and N-(behenyl)acrylamide, or mixtures thereof.

The compositions of some examples of cleaning-agent preparations A according to the present invention may be gathered from TABLES 15-34 below.

TABLE 15
Exemplary Cleaning-Agent Preparations

| Ingredient | Formula | Formula | Formula | Formula | Formula |
|---|---|---|---|---|---|
| (in wt. %) | 61 | 62 | 63 | 64 | 65 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| Anionic | 1.0 to 30 | 1.0 to 30 | 2.0 to 25 | 2.0 to 25 | 5.0 to 20 |
| polymer | | | | | |
| Surfactant | <5.0 | <4.0 | <3.0 | <1.0 | — |
| miscel- | to 100 | to 100 | to 100 | to 100 | to 100 |
| laneous | | | | | |

TABLE 16
Exemplary Cleaning-Agent Preparations

| Ingredient | Formula | Formula | Formula | Formula | Formula |
|---|---|---|---|---|---|
| (in wt. %) | 66 | 67 | 68 | 69 | 70 |
| Water | 30 to 80 | 30 to 80 | 35 to 75 | 35 to 75 | 40 to 70 |
| EDDS | 3.0 to 40 | 5.0 to 30 | 5.0 to 30 | 10 to 20 | 10 to 20 |
| Anionic | 1.0 to 30 | 1.0 to 30 | 2.0 to 25 | 2.0 to 25 | 5.0 to 20 |
| polymer | | | | | |
| Surfactant | <5.0 | <4.0 | <3.0 | <1.0 | — |
| miscel- | to 100 | to 100 | to 100 | to 100 | to 100 |
| laneous | | | | | |

TABLE 17
Exemplary Cleaning-Agent Preparations

| Ingredient | Formula | Formula | Formula | Formula | Formula |
|---|---|---|---|---|---|
| (in wt. %) | 71 | 72 | 73 | 74 | 75 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| Anionic | 1.0 to 30 | 1.0 to 30 | 2.0 to 25 | 2.0 to 25 | 5.0 to 20 |
| polymer | | | | | |
| Surfactant | <5.0 | <4.0 | <3.0 | <1.0 | — |
| miscel- | to 100 | to 100 | to 100 | to 100 | to 100 |
| laneous | | | | | |

TABLE 18
Exemplary Cleaning-Agent Preparations

| Ingredient | Formula | Formula | Formula | Formula | Formula |
|---|---|---|---|---|---|
| (in wt. %) | 76 | 77 | 78 | 79 | 80 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Surfactant | <5.0 | <4.0 | <3.0 | <1.0 | — |
| miscel- | to 100 | to 100 | to 100 | to 100 | to 100 |
| laneous | | | | | |

TABLE 19
Exemplary Cleaning-Agent Preparations

| Ingredient | Formula | Formula | Formula | Formula | Formula |
|---|---|---|---|---|---|
| (in wt. %) | 76a | 77a | 78a | 79a | 80a |
| Water | 30 to 80 | 30 to 80 | 35 to 75 | 35 to 75 | 40 to 70 |
| EDDS | 3.0 to 40 | 5.0 to 30 | 5.0 to 30 | 10 to 20 | 10 to 20 |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Surfactant | <5.0 | <4.0 | <3.0 | <1.0 | — |
| miscel- | to 100 | to 100 | to 100 | to 100 | to 100 |
| laneous | | | | | |

TABLE 20
Exemplary Cleaning-Agent Preparations

| Ingredient | Formula | Formula | Formula | Formula | Formula |
|---|---|---|---|---|---|
| (in wt. %) | 81 | 82 | 83 | 84 | 85 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Phosphate | — | — | — | — | — |
| Surfactant | <5.0 | <4.0 | <3.0 | <1.0 | — |
| miscel- | to 100 | to 100 | to 100 | to 100 | to 100 |
| laneous | | | | | |

TABLE 21
Exemplary Cleaning-Agent Preparations

| Ingredient | Formula | Formula | Formula | Formula | Formula |
|---|---|---|---|---|---|
| (in wt. %) | 81a | 82a | 83a | 84a | 85a |
| Water | 30 to 80 | 30 to 80 | 35 to 75 | 35 to 75 | 40 to 70 |
| EDDS | 3.0 to 40 | 5.0 to 30 | 5.0 to 30 | 10 to 20 | 10 to 20 |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Phosphate | — | — | — | — | — |
| Surfactant | <5.0 | <4.0 | <3.0 | <1.0 | — |
| miscel- | to 100 | to 100 | to 100 | to 100 | to 100 |
| laneous | | | | | |

TABLE 22
Exemplary Cleaning Agent Preparations

| Ingredient | Formula | Formula | Formula | Formula | Formula |
|---|---|---|---|---|---|
| (in wt. %) | 86 | 87 | 88 | 89 | 90 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| (Hydrogen)- | 2.0 to 20 | 2.0 to 20 | 3.0 to 15 | 3.0 to 15 | 4.0 to 12 |
| carbonate | | | | | |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Phosphate | — | — | — | — | — |
| Surfactant | <5.0 | <4.0 | <3.0 | <1.0 | — |
| miscel- | to 100 | to 100 | to 100 | to 100 | to 100 |
| laneous | | | | | |

TABLE 23
Exemplary Cleaning-Agent Preparations

| Ingredient | Formula | Formula | Formula | Formula | Formula |
|---|---|---|---|---|---|
| (in wt. %) | 86 | 87 | 88 | 89 | 90 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| (Hydrogen)- | 2.0 to 20 | 2.0 to 20 | 3.0 to 15 | 3.0 to 15 | 4.0 to 12 |
| carbonate | | | | | |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Phosphate | — | — | — | — | — |
| Surfactant | <5.0 | <4.0 | <3.0 | <1.0 | — |
| miscel- | to 100 | to 100 | to 100 | to 100 | to 100 |
| laneous | | | | | |

TABLE 24
Exemplary Cleaning-Agent Preparations

| Ingredient | Formula | Formula | Formula | Formula | Formula |
|---|---|---|---|---|---|
| (in wt. %) | 86a | 87a | 88a | 89a | 90a |
| Water | 30 to 80 | 30 to 80 | 35 to 75 | 35 to 75 | 40 to 70 |
| EDDS | 3.0 to 40 | 5.0 to 30 | 5.0 to 30 | 10 to 20 | 10 to 20 |
| (Hydrogen)- | 2.0 to 20 | 2.0 to 20 | 3.0 to 15 | 3.0 to 15 | 4.0 to 12 |
| carbonate | | | | | |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Phosphate | — | — | — | — | — |
| Surfactant | <5.0 | <4.0 | <3.0 | <1.0 | — |
| miscel- | to 100 | to 100 | to 100 | to 100 | to 100 |
| laneous | | | | | |

TABLE 25
Exemplary Cleaning-Agent Preparations

| Ingredient | Formula | Formula | Formula | Formula | Formula |
|---|---|---|---|---|---|
| (in wt. %) | 91 | 92 | 93 | 94 | 95 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| Phosphonate | 0.5 to 15 | 0.5 to 15 | 1.0 to 10 | 1.0 to 10 | 1.5 to 6.0 |
| (Hydrogen)- | 2.0 to 20 | 2.0 to 20 | 3.0 to 15 | 3.0 to 15 | 4.0 to 12 |
| carbonate | | | | | |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Phosphate | — | — | — | — | — |
| Surfactant | <5.0 | <4.0 | <3.0 | <1.0 | — |
| miscel- | to 100 | to 100 | to 100 | to 100 | to 100 |
| laneous | | | | | |

TABLE 26
Exemplary Cleaning-Agent Preparations

| Ingredient | Formula | Formula | Formula | Formula | Formula |
|---|---|---|---|---|---|
| (in wt. %) | 91a | 92a | 93 a | 94a | 95a |
| Water | 30 to 80 | 30 to 80 | 35 to 75 | 35 to 75 | 40 to 70 |
| EDDS | 3.0 to 40 | 5.0 to 30 | 5.0 to 30 | 10 to 20 | 10 to 20 |
| Phosphonate | 0.5 to 15 | 0.5 to 15 | 1.0 to 10 | 1.0 to 10 | 1.5 to 6.0 |
| (Hydrogen)- | 2.0 to 20 | 2.0 to 20 | 3.0 to 15 | 3.0 to 15 | 4.0 to 12 |
| carbonate | | | | | |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Phosphate | — | — | — | — | — |
| Surfactant | <5.0 | <4.0 | <3.0 | <1.0 | — |
| miscel- | to 100 | to 100 | to 100 | to 100 | to 100 |
| laneous | | | | | |

TABLE 27
Exemplary Cleaning-Agent Preparations

| Ingredient | Formula | Formula | Formula | Formula | Formula |
|---|---|---|---|---|---|
| (in wt. %) | 96 | 97 | 98 | 99 | 100 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| Phosphonate | 0.5 to 15 | 0.5 to 15 | 1.0 to 10 | 1.0 to 10 | 1.5 to 6.0 |
| (Hydrogen)- | 2.0 to 20 | 2.0 to 20 | 3.0 to 15 | 3.0 to 15 | 4.0 to 12 |
| carbonate | | | | | |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Silicate | — | — | — | — | — |
| Surfactant | <5.0 | <4.0 | <3.0 | <1.0 | — |
| miscel- | to 100 | to 100 | to 100 | to 100 | to 100 |
| laneous | | | | | |

TABLE 28
Exemplary Cleaning-Agent Preparations

| Ingredient | Formula | Formula | Formula | Formula | Formula |
|---|---|---|---|---|---|
| (in wt. %) | 96a | 97a | 98a | 99a | 100a |
| Water | 30 to 80 | 30 to 80 | 35 to 75 | 35 to 75 | 40 to 70 |
| EDDS | 3.0 to 40 | 5.0 to 30 | 5.0 to 30 | 10 to 20 | 10 to 20 |
| Phosphonate | 0.5 to 15 | 0.5 to 15 | 1.0 to 10 | 1.0 to 10 | 1.5 to 6.0 |
| (Hydrogen)- | 2.0 to 20 | 2.0 to 20 | 3.0 to 15 | 3.0 to 15 | 4.0 to 12 |
| carbonate | | | | | |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Silicate | — | — | — | — | — |
| Surfactant | <5.0 | <4.0 | <3.0 | <1.0 | — |
| miscel- | to 100 | to 100 | to 100 | to 100 | to 100 |
| laneous | | | | | |

TABLE 29
Exemplary Cleaning-Agent Preparations

| Ingredient | Formula | Formula | Formula | Formula | Formula |
|---|---|---|---|---|---|
| (in wt. %) | 101 | 102 | 103 | 104 | 105 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| Phosphonate | 0.5 to 15 | 0.5 to 15 | 1.0 to 10 | 1.0 to 10 | 1.5 to 6.0 |
| (Hydrogen)- | 2.0 to 20 | 2.0 to 20 | 3.0 to 15 | 3.0 to 15 | 4.0 to 12 |
| carbonate | | | | | |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Bleaching | — | — | — | — | — |
| agent | | | | | |
| Surfactant | <5.0 | <4.0 | <3.0 | <1.0 | — |
| miscel- | to 100 | to 100 | to 100 | to 100 | to 100 |
| laneous | | | | | |

TABLE 30
Exemplary Cleaning-Agent Preparations

| Ingredient | Formula | Formula | Formula | Formula | Formula |
|---|---|---|---|---|---|
| (in wt. %) | 101a | 102a | 103a | 104a | 105a |
| Water | 30 to 80 | 30 to 80 | 35 to 75 | 35 to 75 | 40 to 70 |
| EDDS | 3.0 to 40 | 5.0 to 30 | 5.0 to 30 | 10 to 20 | 10 to 20 |
| Phosphonate | 0.5 to 15 | 0.5 to 15 | 1.0 to 10 | 1.0 to 10 | 1.5 to 6.0 |
| (Hydrogen)- | 2.0 to 20 | 2.0 to 20 | 3.0 to 15 | 3.0 to 15 | 4.0 to 12 |
| carbonate | | | | | |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Bleaching | — | — | — | — | — |
| agent | | | | | |
| Surfactant | <5.0 | <4.0 | <3.0 | <1.0 | — |
| miscel- | to 100 | to 100 | to 100 | to 100 | to 100 |
| laneous | | | | | |

TABLE 31
Exemplary Cleaning-Agent Preparations

| Ingredient | Formula | Formula | Formula | Formula | Formula |
|---|---|---|---|---|---|
| (in wt. %) | 106 | 107 | 108 | 109 | 110 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| Phosphonate | 0.5 to 15 | 0.5 to 15 | 1.0 to 10 | 1.0 to 10 | 1.5 to 6.0 |
| (Hydrogen)- | 2.0 to 20 | 2.0 to 20 | 3.0 to 15 | 3.0 to 15 | 4.0 to 12 |
| carbonate | | | | | |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Enzyme | — | — | — | — | — |
| Surfactant | <5.0 | <4.0 | <3.0 | <1.0 | — |
| miscel- | to 100 | to 100 | to 100 | to 100 | to 100 |
| laneous | | | | | |

TABLE 32
Exemplary Cleaning-Agent Preparations

| Ingredient | Formula | Formula | Formula | Formula | Formula |
|---|---|---|---|---|---|
| (in wt. %) | 106a | 107a | 108a | 109a | 110a |
| Water | 30 to 80 | 30 to 80 | 35 to 75 | 35 to 75 | 40 to 70 |
| EDDS | 3.0 to 40 | 5.0 to 30 | 5.0 to 30 | 10 to 20 | 10 to 20 |
| Phosphonate | 0.5 to 15 | 0.5 to 15 | 1.0 to 10 | 1.0 to 10 | 1.5 to 6.0 |
| (Hydrogen)- | 2.0 to 20 | 2.0 to 20 | 3.0 to 15 | 3.0 to 15 | 4.0 to 12 |
| carbonate | | | | | |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Enzyme | — | — | — | — | — |
| Surfactant | <5.0 | <4.0 | <3.0 | <1.0 | — |
| miscel- | to 100 | to 100 | to 100 | to 100 | to 100 |
| laneous | | | | | |

TABLE 33
Exemplary Cleaning-Agent Preparations

| Ingredient | Formula | Formula | Formula | Formula | Formula |
|---|---|---|---|---|---|
| (in wt. %) | 111 | 112 | 113 | 114 | 115 |
| Water | 30 to 80 | 30 to 80 | 35 to 75 | 35 to 75 | 40 to 70 |
| Citrate | 2.0 to 50 | 4.0 to 40 | 4.0 to 40 | 5.0 to 30 | 5.0 to 30 |
| EDDS | 3.0 to 40 | 5.0 to 30 | 5.0 to 30 | 10 to 20 | 10 to 20 |
| Phosphonate | 0.5 to 15 | 0.5 to 15 | 1.0 to 10 | 1.0 to 10 | 1.5 to 6.0 |
| (Hydrogen)- | 2.0 to 20 | 2.0 to 20 | 3.0 to 15 | 3.0 to 15 | 4.0 to 12 |
| carbonate | | | | | |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Phosphate | <10 | <3.0 | <1.0 | — | — |
| Silicate | <5.0 | <3.0 | <1.0 | — | — |
| Bleaching | — | — | — | — | — |
| gent | | | | | |
| Enzyme | — | — | — | — | — |
| Surfactant | <5.0 | <4.0 | <3.0 | <1.0 | — |
| miscel- | to 100 | to 100 | to 100 | to 100 | to 100 |
| laneous | | | | | |

TABLE 34
Exemplary Cleaning-Agent Preparations

| Ingredient | Formula | Formula | Formula | Formula | Formula |
|---|---|---|---|---|---|
| (in wt. %) | 111a | 112a | 113a | 114a | 115a |
| Water | 30 to 80 | 30 to 80 | 35 to 75 | 35 to 75 | 40 to 70 |
| EDDS | 3.0 to 40 | 5.0 to 30 | 5.0 to 30 | 10 to 20 | 10 to 20 |
| Phosphonate | 0.5 to 15 | 0.5 to 15 | 1.0 to 10 | 1.0 to 10 | 1.5 to 6.0 |
| (Hydrogen)- | 2.0 to 20 | 2.0 to 20 | 3.0 to 15 | 3.0 to 15 | 4.0 to 12 |
| carbonate | | | | | |
| Alkali | 2.0 to 20 | 2.0 to 20 | 3.0 to 15 | 3.0 to 15 | 4.0 to 12 |
| hydroxide | | | | | |
| Anionic | 1.0 to 30 | 1.0 to 30 | 2.0 to 25 | 2.0 to 25 | 5.0 to 20 |
| polymer | | | | | |
| Phosphate | <10 | <3.0 | <1.0 | — | — |
| Silicate | <5.0 | <3.0 | <1.0 | — | — |
| Bleaching | — | — | — | — | — |
| agent | | | | | |
| Enzyme | — | — | — | — | — |
| Surfactant | <5.0 | <4.0 | <3.0 | <1.0 | — |
| miscel- | to 100 | to 100 | to 100 | to 100 | to 100 |
| laneous | | | | | |

In addition to the builders described above, and water, the cleaning-agent preparations A according to the present invention can contain further ingredients, for example active substances from the group of the corrosion inhibitors as well as the scents or dyes not having washing or cleaning activity. In contrast to usual washing or cleaning agents, however, preferred cleaning-agent preparations A according to the present invention contain these further ingredients to only a subordinate degree.

Individual fragrance compounds, e.g. the synthetic products of the ester, ether, aldehyde, ketone, alcohol, and hydrocarbon types, can be used in the context of the present invention as perfume oils or scents. Preferably, however, mixtures of different fragrances that together produce an attractive scent note are used. Such perfume oils can also contain natural fragrance mixtures such as those accessible from plant sources, e.g. pine, citrus, jasmine, patchouli, rose, or ylang-ylang oil.

Preferred dyes, the selection of which will present no difficulty whatsoever to the skilled artisan, possess excellent shelf stability and insensitivity to the other ingredients of the agents and to light, and no pronounced substantivity with respect to the substrates, for example textiles, glass, ceramic, or plastic tableware, to be treated with the dye-containing agents, in order not to color them.

Despite their high degree of both physical and chemical stability, the cleaning-agent preparations A according to the present invention are notable for a low level of formulation complexity. This low degree of complexity simplifies manufacture of the cleaning agents and thus reduces the costs occurring in the context of preparation of these cleaning agents. Preferred cleaning agents according to the present invention are, for this reason, characterized in that alongside the essential constituents a) and b) they comprise at most three, by preference at most two, particularly preferably at most one, and in particular no further constituents having washing or cleaning activity. The weight proportion of further ingredients having washing or cleaning activity is by preference equal to less than 10 wt %, by preference less than 5 wt %, particularly preferably less than 2 wt %, and very particularly preferably less than 1.0 wt %.

In particular, those cleaning-agent preparations A that contain less than 10 wt %, by preference less than 5 wt %, and in particular less than 2 wt % bleaching agent are preferred. In particular, those cleaning-agent preparations A that are free of bleaching agents are particularly preferred.

In particular, those cleaning-agent preparations A that contain less than 8 wt %, by preference less than 3 wt %, and in particular less than 1 wt % enzyme preparation are furthermore preferred. In particular, those cleaning-agent preparations A that are free of enzyme preparations are particularly preferred.

Even if the aforesaid further ingredients having washing or cleaning activity are contained in, i.e. are mixed directly with, the cleaning-agent preparations A according to the present invention only to a subordinate degree, it is nevertheless desirable to package these further ingredients together with the preparations according to the present invention to yield a washing or cleaning agent. One skilled in the art may choose, for this purpose, from all packaging forms known to him or her for combination products having a liquid component; those combination products that enable packaging together with two, three, four, or more liquid preparations separated from one another have proven particularly suitable.

In a further embodiment, the cleaning agents according to the present invention are combined with one or more further cleaning agents.

In another embodiment of the present invention, a cleaning-agent combination is provided, comprising: (a) a liquid cleaning-agent preparation A according to the present invention; and (b) at least one, by preference at least two further cleaning-agent preparations different from A.

Preferred liquid preparations according to the present invention are characterized in that they are present in a manner packaged together with one, by preference two or three further liquid cleaning-agent preparations to yield a combination product. The further one, two, or three cleaning-agent preparations have, in this context, a composition deviating from the builder-containing cleaning-agent preparation A according to the present invention. The further one, two, or three liquid cleaning-agent preparations are by preference phosphate-free.

The further liquid cleaning-agent preparations can contain further substances having washing or cleaning activity; substances from the group of the surfactants, the enzymes, the glass corrosion inhibitors, the corrosion inhibitors, and the scents and dyes are preferred. Bleaching agents and bleach activators are also usable in specific embodiments.

The further cleaning-agent preparations combined with the cleaning-agent preparation A according to the present invention are by preference surfactant- and/or enzyme- and/or bleaching agent-containing cleaning agents.

A preferred washing- or cleaning-agent combination according to the present invention comprises: (a) a cleaning-agent preparation A according to the present invention; (b) a cleaning-agent preparation B containing: (b0) at least one enzyme having washing or cleaning activity.

Included among the enzymes used with particular preference in the cleaning-agent preparation B are, in particular, proteases, amylases, lipases, hemicellulases, cellulases, perhydrolases, or oxidoreductases, as well as, by preference, mixtures thereof. These enzymes are in principle of natural origin; proceeding from the natural molecules, improved variants are available for use in washing or cleaning agents and are used in correspondingly preferred fashion. Washing or cleaning agents contain enzymes by preference in total quantities from 1×10⁻⁶ to 5 wt %, based on active protein. The protein concentration can be determined with the aid of known methods, for example the BCA method or the biuret method.

The stabilizing effect according to the present invention was observed to a particular degree with the amylases and the proteases, and for that reason liquid cleaning-agent preparations A according to the present invention wherein they contain an enzyme having washing or cleaning activity from the group of the amylases and/or proteases are preferred.

Another preferred washing- or cleaning-agent combination according to the present invention comprises:

(a) a cleaning-agent preparation A according to the present invention; and
(b) a cleaning-agent preparation C containing:

(i) at least one nonionic surfactant; and

(ii) water.

Packaging of the combination of cleaning agents that is described above occurs in the form of receiving chambers separated from one another, each of said receiving chambers containing one of the cleaning agents combined with one another. Examples of such combination forms are cartridges having two, three, four, or more receiving chambers separated from one another, for example two-, three-, four, or multi-chamber bottles. Undesired reactions due to chemical incompatibility can be precluded by separation of the cleaning agents having different compositions.

A further subject of the present Application is a cleaning-agent presentation form comprising: (a) a cleaning-agent preparation A according to the present invention, in a quantity sufficient for carrying out an automatic dishwashing method or automatic textile washing method at least twice, by preference at least four times, and in particular at least eight times; and (b) a cartridge for the cleaning-agent preparation A.

A further subject of the present Application is a cleaning-agent presentation form comprising: (a) a cleaning-agent preparation A according to the present invention, in a quantity sufficient for carrying out an automatic dishwashing method or automatic textile washing method at least twice, by preference at least four times, and in particular at least eight times; (b) at least one further cleaning-agent preparation B, different from A, in a quantity sufficient for carrying out an automatic dishwashing method or automatic textile washing method at least twice, by preference at least four times, and in particular at least eight times; and (c) a cartridge for the cleaning-agent preparations A and B, in which cartridge the cleaning-agent preparations A and B are present in receiving chambers separated from one another.

Additionally claimed is a cleaning-agent presentation form comprising: (a) a cleaning-agent preparation A according to the present invention, in a quantity sufficient for carrying out an automatic dishwashing method or automatic textile washing method at least twice, by preference at least four times, and in particular at least eight times; (b) at least one further cleaning-agent preparation B, different from A, in a quantity sufficient for carrying out an automatic dishwashing method or automatic textile washing method at least twice, by preference at least four times, and in particular at least eight times; (c) at least one further cleaning-agent preparation C, different from A and B, in a quantity sufficient for carrying out an automatic dishwashing method or automatic textile washing method at least twice, by preference at least four times, and in particular at least eight times; and (d) a cartridge for the cleaning-agent preparations A, B, and C, in which cartridge the cleaning-agent preparations A, B, and C are present in receiving chambers separated from one another.

A further subject of the present Application is a cleaning-agent dispensing system comprising: (a) a cleaning-agent preparation A according to the present invention, in a quantity sufficient for carrying out an automatic dishwashing method or automatic textile washing method at least twice, by preference at least four times, and in particular at least eight times; (b) a cartridge for the cleaning-agent preparation A; and (c) a dispenser connected or connectable to the cartridge.

In a preferred embodiment, the previously described cartridges of the cleaning-agent presentation forms are equipped with a dispenser detachable from the cartridge. A dispenser of this kind can be connected to the cartridge, for example, by means of an adhesive, latching, snap-lock, or insertion connection. Separation of the cartridge and dispenser simplifies, for example, filling of the cartridge. Alternatively, the detachable connection of the cartridge and dispenser enables replacement of the cartridges on the dispenser. Such replacement may be indicated, for example, in the context of a change in the cleaning program or after the cartridge has been completely emptied.

A further subject of the present Application is a cleaning-agent dispensing system comprising: (a) a cleaning-agent preparation A according to the present invention, in a quantity sufficient for carrying out an automatic dishwashing method or automatic textile washing method at least twice, by preference at least four times, and in particular at least eight times; (b) a cartridge for the cleaning-agent preparation A; and (c) a dispenser connected detachably to the cartridge.

A further subject of the present Application is a cleaning-agent dispensing system comprising: (a) a cleaning-agent preparation A according to the present invention, in a quantity sufficient for carrying out an automatic dishwashing method or automatic textile washing method at least twice, by preference at least four times, and in particular at least eight times; (b) at least one further cleaning-agent preparation B, different from A, in a quantity sufficient for carrying out an automatic dishwashing method or automatic textile washing method at least twice, by preference at least four times, and in particular at least eight times; (c) a cartridge for the cleaning-agent preparations A and B, in which cartridge the cleaning-agent preparations A and B are present in receiving chambers separated from one another; and (d) a dispenser connected detachably to the cartridge.

A particularly preferred subject of this Application is a cleaning-agent dispensing system comprising: (a) a cleaning-agent preparation A according to the present invention, in a quantity sufficient for carrying out an automatic dishwashing method or automatic textile washing method at least twice, by preference at least four times, and in particular at least eight times; (b) at least one further cleaning-agent preparation B, different from A, in a quantity sufficient for carrying out an automatic dishwashing method or automatic textile washing method at least twice, by preference at least four times, and in particular at least eight times; (c) at least one further cleaning-agent preparation C, different from A and B, in a quantity sufficient for carrying out an automatic dishwashing method or automatic textile washing method at least twice, by preference at least four times, and in particular at least eight times; (d) a cartridge for the cleaning-agent preparations A, B, and C, in which cartridge the cleaning-agent preparations A, B, and C are present in receiving chambers separated from one another; and (e) a dispenser connected detachably to the cartridge.

Cleaning-agent presentation forms in which the cartridge and the dispenser are connected non-detachably to one another are of course also conceivable.

A further subject of the present Application is a cleaning-agent dispensing system comprising: (a) a cleaning-agent preparation A according to the present invention, in a quantity sufficient for carrying out an automatic dishwashing method or automatic textile washing method at least twice, by preference at least four times, and in particular at least eight times; (b) a cartridge for the cleaning-agent preparation A; and (c) a dispenser connected non-detachably to the cartridge.

A further subject of the present Application is a cleaning-agent dispensing system comprising: (a) a cleaning-agent preparation A according to the present invention, in a quantity sufficient for carrying out an automatic dishwashing method or automatic textile washing method at least twice, by preference at least four times, and in particular at least eight times; (b) at least one further cleaning-agent preparation B, different from A, in a quantity sufficient for carrying out an automatic dishwashing method or automatic textile washing method at least twice, by preference at least four times, and in particular at least eight times; (c) a cartridge for the cleaning-agent preparations A and B, in which cartridge the cleaning-agent preparations A and B are present in receiving chambers separated from one another; and (d) a dispenser connected non-detachably to the cartridge.

A particularly preferred subject of this Application is a cleaning-agent dispensing system comprising: (a) a cleaning-agent preparation A according to the present invention, in a quantity sufficient for carrying out an automatic dishwashing method or automatic textile washing method at least twice, by preference at least four times, and in particular at least eight times; (b) at least one further cleaning-agent preparation B, different from A, in a quantity sufficient for carrying out an automatic dishwashing method or automatic textile washing method at least twice, by preference at least four times, and in particular at least eight times; (c) at least one further cleaning-agent preparation C, different from A and B, in a quantity sufficient for carrying out an automatic dishwashing method or automatic textile washing method at least twice, by preference at least four times, and in particular at least eight times; (d) a cartridge for the cleaning-agent preparations A, B, and C, in which cartridge the cleaning-agent preparations A, B, and C are present in receiving chambers separated from one another; and (e) a dispenser connected non-detachably to the cartridge.

In a preferred embodiment, the aforesaid cleaning-agent dispensing systems comprising a cleaning agent according to the present invention (as well as optionally one or two further cleaning agents different from the cleaning agent according to the present invention), a cartridge, and a dispenser connected detachably to the cartridge are present in a shared enclosing package, the filled cartridge and the dispenser being, particularly preferably, contained separately from one another in the enclosing package. The enclosing package serves for storage, transport, and presentation of the cleaning-agent presentation form according to the present invention and protects it from soiling, impact, and shock. For the purpose of presentation in particular, the enclosing package should be embodied to be transparent at least in part.

Alternatively or as a supplement to an enclosing package, the possibility of course exists of marketing the cleaning agents, cleaning-agent combinations, or cleaning-agent presentation forms according to the present invention in conjunction with an automatic dishwasher or textile washing machine. Such a combination is advantageous in particular in those cases in which the execution sequence of the automatic dishwashing method and/or textile washing method (e.g. duration, temperature profile, water delivery) and the cleaning-agent formulation and/or the control electronics of the dispenser are coordinated with one another.

The dispensing system according to the present invention is made up of the basic modules of a cartridge filled with the cleaning agent according to the present invention and a dispenser couplable to the cartridge, which dispenser is in turn constituted from further assemblies such as, for example, a component carrier, actuator, closure element, sensor, energy source, and/or control unit.

It is preferred that the dispensing system according to the present invention be movable. “Movable” for purposes of this Application means that the dispensing system is not connected non-detachably to a water-conveying apparatus such as, for example, an automatic dishwasher, washing machine, laundry dryer, or the like, but instead can be removed, for example, from an automatic dishwasher by the user or positioned in an automatic dishwasher, i.e. can be handled independently.

According to an alternative embodiment of the invention, it is also conceivable for the dispenser to be connected, in a manner not detachable by the user, to a water-conveying apparatus such as, for example, an automatic dishwasher, washing machine, laundry dryer, or the like, and for only the cartridge to be movable.

Because the preparations to be dispensed can have a pH of between 2 and 12, depending on the intended utilization, all the components of the dispensing system that come into contact with the preparations should have corresponding acid resistance and/or alkali resistance. With judicious choice of material selection, these components should also be very largely chemically inert, for example against nonionic surfactants, enzymes, and/or scents.

Cartridge

For purposes of the present Application, a “cartridge” is understood as a packaging means that is suitable for encasing or holding together flowable or scatterable preparations, and is couplable to a dispenser in order to deliver the preparation.

In particular, a cartridge can also encompass multiple chambers that are fillable with compositions differing from one another. It is also conceivable for a plurality of containers to be arranged into one cartridge unit.

It is advantageous for the cartridge to comprise at least one outlet opening which is arranged such that gravity-effected release of preparation from the container can be brought about in the utilization position of the dispenser. As a result, no further conveying means are required for the release of preparation from the container. In this way, the construction of the dispenser can be kept simple and manufacturing costs can be kept low.

In a preferred embodiment of the invention, at least one second chamber is provided for receiving at least one second flowable or scatterable preparation, the second chamber comprising at least one outlet opening which is arranged such that a gravity-effected product release from the second chamber is brought about with the dispenser in the utilization position. The arrangement of a second chamber is advantageous in particular when preparations that are not usually shelf-stable with one another, for example bleaching agents and enzymes, are stocked in the containers that are separated from one another.

It is furthermore conceivable for more than two, in particular three to four chambers to be provided in and/or on a cartridge. In particular, one of the chambers can be configured to deliver volatile preparations, for instance a scent, into the surroundings.

In a further embodiment of the invention, the cartridge is embodied in one piece. As a result, the cartridges can be embodied economically in one manufacturing step, in particular using suitable blow molding methods. The chambers of a cartridge can in this context be separated from one another by, for example, webs or material bridges.

The cartridge can also be formed from multiple pieces, using components manufactured by injection molding and then joined together.

It is furthermore conceivable for the cartridge to be shaped in multi-piece fashion such that at least one chamber, preferably all the chambers, are individually removable from, or insertable into, the dispenser. This makes it possible, if a preparation from one chamber is consumed at a different rate, to replace an already empty chamber while the others, which may still be filled with preparation, remain in the dispenser. Targeted and demand-compatible refilling of the individual chambers and/or their preparations can thereby be achieved.

The chambers of a cartridge can be fastened to one another using suitable connection methods, thereby forming a container unit. The chambers can be fastened detachably or nondetachably to one another by a suitable positive, frictionally engaged, or integral-type connection. In particular, fastening can be effected by one or more of the connection types from the group of the snap-in connections, hook-and-loop connections, press connections, melt connections, adhesive connections, welded connections, soldered connections, screw connections, keyed connections, clamped connections or flip-closure connections In particular, fastening can also be embodied by a heat-shrink sleeve, which in a heated state is pulled over all or portions of the cartridge, and in the cooled state fixedly surrounds the chambers and/or the cartridge.

In order to provide advantageous residual emptying properties for the chambers, the bottom of the chambers can be inclined in a funnel shape toward the delivery opening. Moreover, the inner wall of a chamber can be embodied, by suitable material selection and/or surface configuration, such that little material adhesion of the preparation onto the internal chamber wall occurs. This action, too, allows the residual emptying capability of a chamber to be further optimized.

The chambers of a cartridge can have identical or differing volumetric capacities. In a configuration having two chambers, the ratio of the chamber volumes is preferably 5:1, in a configuration having three chambers preferably 4:1:1, these configurations in particular being suitable for use in automatic dishwashers.

As mentioned above, the cartridge preferably possesses three chambers. For use of such a cartridge in an automatic dishwasher, it is particularly preferred that the first chamber contain an alkaline cleaning preparation, the second chamber a enzymatic preparation, and the third chamber a rinse aid, the volume ratio of the chambers being equal to approximately 4:1:1.

A dispensing chamber can be embodied in or on a chamber before the outlet opening in the flow direction of the preparation. The dispensing chamber defines the quantity of preparation that, upon the release of preparation from the chamber, is delivered to the surroundings. This is particularly advantageous when the closure element of the dispenser, which brings about delivery of preparation from a chamber to the surroundings, can be placed only into a delivery state and a closed state, without monitoring of the quantity delivered. The dispensing chamber then ensures that a predefined quantity of preparation is released without direct feedback of the quantity of preparation being delivered. The dispensing chambers can be shaped in single- or multi-piece fashion.

According to a further advantageous refinement of the invention, one or more chambers comprise(s) in each case, in addition to an outlet opening, a respective chamber opening closable in liquid-tight fashion. This chamber opening makes it possible, for example, to refill the preparation stored in that chamber.

In order to vent the cartridge chambers, it is possible to provide venting capabilities in particular in the top region of the cartridge, to ensure pressure equalization between the interior of the cartridge chambers and the surroundings as the fill level drops. These venting capabilities can be embodied, for example as a valve, in particular a silicone slit valve, micro-openings in the cartridge wall, or the like.

If, according to a further embodiment, the cartridge chambers are vented not directly but rather via the dispenser, or if no venting is provided, for example when using flexible containers such as for example pouches, this has the advantage that at elevated temperatures in the course of a washing cycle of a dishwasher, a pressure is built up due to heating of the chamber contents, which pressure pushes the preparations to be dispensed toward the outlet openings so that a good residual emptying capability for the cartridge is thereby achievable. In addition, with air-free packaging of this kind there is no risk of oxidation of substances of the preparation; this makes a pouch package or even bag-in-bottle package seem useful in particular for oxidation-sensitive preparations.

The cartridge usually has a volumetric capacity of <5000 ml, in particular <1000 ml, preferably <500 ml, particularly preferably <250 ml, very particularly preferably <50 ml.

The cartridge can assume any desired three-dimensional shape. It can for example be cubic, spherical or plate-like in configuration.

The cartridge and the dispenser can in particular be configured, with regard to their three-dimensional shape, in such a way that they ensure the least possible loss of useful volume in particular in an automatic dishwasher.

For utilization of the dispenser in automatic dishwashers, it is particularly advantageous to shape the device by analogy with tableware to be cleaned in automatic dishwashers. It can, for example, be plate-shaped, having approximately the dimensions of a dinner plate. As a result, the dispenser can be positioned in space-saving fashion, for example, in the lower rack of the dishwasher. Furthermore, correct positioning of the dispensing unit is immediately and intuitively evident to the user thanks to the plate-like shape. The cartridge preferably has a ratio of height to width to depth of between 5:5:1 and 50:50:1, particularly preferably approximately 10:10:1. The “slender” embodiment of the dispenser and the cartridge makes it possible in particular to position the device in the lower loading rack of an automatic dishwasher in the receptacles provided for plates. This has the advantage that the preparations delivered from the dispenser travel directly into the washing bath and cannot adhere to other items being washed.

Commercially available household automatic dishwashers are usually designed so that provision is made to arrange larger items to be washed, for instance pans or large plates, in the lower rack of the automatic dishwasher. In order to prevent the user from positioning the dispensing system less than optimally in the upper rack, in an advantageous embodiment of the invention, the dispensing system is dimensioned to enable the dispensing system to be positioned only in the receptacles of the lower rack. To this end, the width and height of the dispensing system can be selected to be, in particular, between 150 mm and 300 mm, particularly preferably between 175 mm and 250 mm.

It is also conceivable, however, to embody the dispensing unit in a cup shape, with a substantially circular or square base outline.

In order to protect heat-sensitive constituents of a preparation present in a cartridge from the effect of heat, it is advantageous to manufacture the cartridge from a material having low thermal conductivity.

Another possibility for reducing the influence of heat on a preparation in a chamber of the cartridge is to insulate the chamber using suitable actions, for example by using thermal insulation materials, such as for instance polystyrene foam, which suitably surround the chamber or cartridge entirely or in part.

In a preferred embodiment of the invention, the cartridge comprises an RFID label that contains at least information about the contents of the cartridge and that is readable by the sensor unit.

This information can be used in order to select a dispensing program stored in the control unit. It is thereby possible to ensure that the optimum dispensing program for a specific preparation is always used. Provision can also be made that, in the absence of an RFID label or in the case of an RFID label having an incorrect or defective identifier, no dispensing is performed by the dispenser and instead an optical or acoustic signal is generated which notifies the user of the presence of the fault.

In order to preclude incorrect use of the cartridge, the cartridges can also comprise structural elements that interact with corresponding elements of the dispenser on the lock-and-key principle, so that for example only cartridges of a specific type can be coupled to the dispenser. This embodiment furthermore makes it possible for information about the cartridge coupled to the dispenser to be transmitted to the control unit, with the result that the dispenser can be controlled in a manner coordinated with the contents of the corresponding container.

The cartridge is embodied in particular for the reception of flowable washing or cleaning agents. Particularly preferably, a cartridge of this kind comprises a plurality of chambers for spatially separated reception of preparations of a washing or cleaning agent that each differ from one another.

The cartridge can be embodied so that it can be arranged detachably or fixedly in or on the automatic dishwasher.

Dispenser

The control unit necessary for operation, a sensor unit, and at least one actuator are integrated into the dispenser. Preferably an energy source is likewise arranged in the dispenser.

The dispenser is preferably made up of a water-spray-protected housing that can prevent the penetration into the interior of the dispenser of sprayed water, as can occur, for example, upon use in an automatic dishwasher.

It is particularly preferred that the dispenser encompass at least one first interface that interacts corresponding interface embodied in or on a water-conveying appliance, in particular a water-conveying household appliance, preferably an automatic dishwasher or washing machine, in such a way that a transfer of electrical energy from the water-conveying appliance to the dispenser is effected.

In an embodiment of the invention, the interfaces are embodied by plug connectors. In another embodiment, the interfaces can be embodied such that a wireless transfer of electrical energy is brought about.

In an advantageous refinement of the invention, a second interface is embodied respectively on the dispenser and on the water-conveying appliance, for example an automatic dishwasher, for the transfer of electromagnetic signals that represent in particular operating-state, measurement, and/or control information of the dispenser and/or of the water-conveying appliance such as an automatic dishwasher.

Adapter

Simple coupling of the dispensing system to a water-conveying household appliance can be achieved by means of an adapter. The adapter serves for mechanical and/or electrical connection of the dispensing system to the water-conveying household appliance.

The adapter is connected, preferably fixedly, to a water-conveying line of the household appliance. It is also conceivable, however, to provide the adapter for a position, in or on the household appliance, in which the adapter is contacted by the water flow and/or spray stream of the household appliance.

The adapter makes it possible to configure a dispensing system in both an autonomous and a built-in version. It is also possible to embody the adapter as a kind of charging station for the dispensing system, in which e.g. the energy source of the dispenser is charged or data are exchanged between the dispenser and the adapter.

The adapter can be arranged in an automatic dishwasher on one of the inner walls of the washing chamber, in particular on the inner side of the dishwasher door. It is also conceivable, however, for the adapter as such to be positioned in the water-conveying household appliance in a manner not accessible to the user, so that the dispenser is, for example, inserted into the adapter during assembly with the household appliance, such that the adapter, the dispenser, and the household appliance are embodied in such a way that a cartridge can be coupled by the user to the dispenser.

The cleaning agents, cleaning-agent combinations, or cleaning-agent presentation forms according to the present invention are suitable for use in dishwashing and also for textile cleaning; the use of a cleaning-agent preparation A according to the present invention, a cleaning-agent combination according to the present invention, or a cleaning-agent presentation form according to the present invention for dishwashing in an automatic dishwashing method is nevertheless preferred.

The formulations 1 to 115a disclosed in the tables above are particularly suitable for the all of the uses discussed above.

As stated previously, the cleaning agents according to the present invention are notable for particular physical and chemical stability, in particular with respect to temperature fluctuations. The cleaning agents according to the present invention are thus exceptionally suitable for dispensing by means of a dispensing system present in the interior of a washing machine or automatic dishwasher. A dispensing system of this kind, which can be integrated immovably into the interior of the washing machine or automatic dishwasher (appliance-integrated dispenser) but can also, of course, be introduced into the interior as a movable apparatus (autonomous dispenser), contains several times the quantity of cleaning agent necessary for carrying out an automatic cleaning method.

“Movable” means, for purposes of this Application, that the delivery and dispensing system is not connected non-detachably to an apparatus such as, for example, an automatic dishwasher, washing machine, laundry dryer, or the like, but is, for example, removable from or positionable in an automatic dishwasher.

The use of a liquid cleaning-agent preparation A according to the present invention or a cleaning-agent combination according to the present invention to fill: (i) a cartridge, integrated immovably into the interior of an automatic dishwasher and/or textile washing machine, of a dispensing system; or (ii) a movable cartridge, provided for positioning in the interior of an automatic dishwasher and/or textile washing machine, of a dispensing system, with a quantity of said liquid cleaning-agent preparation and/or said cleaning-agent combination sufficient for carrying out an automatic dishwashing method and/or automatic textile washing method at least twice, by preference at least four times, and in particular at least eight times, is likewise a subject of this Application.

The formulations 1 to 115a disclosed in the tables are particularly suitable for the uses discussed above.

An example of an immovable cartridge is a container integrated immovably into the interior, for example into the side wall or inner lining of the door, of an automatic dishwasher.

An example of a movable cartridge is a container that is introduced by the consumer into the interior of the automatic dishwasher and remains there throughout the entire course of a cleaning cycle. Such a cartridge can be integrated into the interior, for example by simple placement into the cutlery basket or tableware rack, but can also be removed again by the consumer from the interior of the automatic dishwasher.

Dispensing of the cleaning agent and/or cleaning-agent combination from the cartridge into the interior of the automatic dishwasher occurs, as described above, preferably by means of a dispenser detachable from the cartridge. A dispenser of this kind can be connected to the cartridge by means of an adhesive, latching, snap-lock, or insertion connection. Cartridges having a non-detachably connected dispenser are, however, of course also usable.

Another embodiment of the present invention comprises the use of a cleaning-agent presentation form comprising: (a) a liquid cleaning-agent preparation A according to the present invention in a quantity sufficient for carrying out an automatic dishwashing method and/or automatic textile washing method at least twice, by preference at least four times, and in particular at least eight times; and (b) a cartridge for the cleaning-agent preparation A, wherein said cartridge is the cleaning-agent reservoir for: (i) a dispenser integrated immovably into the interior of an automatic dishwasher and/or textile washing machine; or (ii) a movable dispenser provided for positioning in the interior of an automatic dishwasher and/or textile washing machine.

The formulations 1 to 115a disclosed in the tables are particularly suitable for the aforementioned uses.

The use of a cleaning-agent dispensing system as a cleaning-agent reservoir for an automatic dishwasher is a further subject of the present Application. The formulations 1 to 115a disclosed in the tables are particularly suitable for this use.

Two further subjects of this Application are the use of a cleaning-agent presentation form according to the present invention comprising: (a) a cleaning-agent preparation A according to the present invention in a quantity sufficient for carrying out an automatic dishwashing method and/or automatic textile washing method at least twice, by preference at least four times, and in particular at least eight times; (b) at least one further cleaning-agent preparation B, different from A, in a quantity sufficient for carrying out an automatic dishwashing method and/or automatic textile washing method at least twice, by preference at least four times, and in particular at least eight times; and (c) a cartridge for the cleaning-agent preparations A and B, in which cartridge the cleaning-agent preparations A and B are present in receiving chambers separated from one another, wherein said cartridge is a cleaning-agent reservoir for: (i) a dispenser integrated immovably into the interior of an automatic dishwasher and/or textile washing machine; or (ii) a movable dispenser provided for positioning in the interior of an automatic dishwasher and/or textile washing machine.

The formulations 1 to 115a disclosed in the tables are particularly suitable for the aforementioned uses.

Also claimed is the use of a cleaning-agent presentation form according to the present invention comprising: (a) a cleaning-agent preparation A according to the present invention in a quantity sufficient for carrying out an automatic dishwashing method and/or automatic textile washing method at least twice, by preference at least four times, and in particular at least eight times; (b) at least one further cleaning-agent preparation B, different from A, in a quantity sufficient for carrying out an automatic dishwashing method and/or automatic textile washing method at least twice, by preference at least four times, and in particular at least eight times; (c) at least one further cleaning-agent preparation C, different from A and B, in a quantity sufficient for carrying out an automatic dishwashing method and/or automatic textile washing method at least twice, by preference at least four times, and in particular at least eight times; and (d) a cartridge for the cleaning-agent preparations A, B, and C, in which cartridge the cleaning-agent preparations A, B, and C are present in receiving chambers separated from one another, wherein said cartridge is a cleaning-agent reservoir for: (i) a dispenser integrated immovably into the interior of an automatic dishwasher and/or textile washing machine; or (ii) a movable dispenser provided for positioning in the interior of an automatic dishwasher and/or textile washing machine.

The formulations 1 to 115a disclosed in the tables are particularly suitable for the aforementioned uses.

The cleaning agents and cleaning-agent combinations according to the present invention are, as stated earlier, preferably used as automatic dishwashing agents or as automatic textile washing agents.

A further subject of this application is a method for cleaning tableware in an automatic dishwasher using a liquid cleaning-agent preparation comprising: (a) 15 to 60 wt % builder; (b) 30 to 80 wt % water; and (c) less than 5 wt % surfactant.

A further subject of this Application is likewise a method for cleaning textiles in an textile washing machine using a liquid cleaning-agent preparation comprising: (a) 15 to 60 wt % builder; (b) 30 to 80 wt % water; and (c) less than 5 wt % surfactant.

The cleaning-agent preparations according to the present invention used with particular preference in these methods correspond to the agents described above in detail, by preference to the formulations 1 to 115a disclosed in the tables. To avoid repetition, reference is made at this juncture to the statements made there.

Preferred methods for tableware cleaning and/or textile cleaning are characterized in that the liquid cleaning-agent preparation is dispensed out of a reservoir container present in the automatic dishwasher or textile washing machine, which reservoir contains several times the quantity of cleaning-agent preparation necessary for carrying out one cleaning method, into the interior of the automatic dishwasher and/or textile washing machine. The formulations 1 to 115a disclosed in the tables are particularly suitable for this method.

Dispensing of the cleaning-agent preparation according to the present invention occurs by preference in the course of the main cleaning cycle of the automatic dishwashing method and/or automatic textile washing method.

As stated previously, the reservoir container used for dispensing can be a reservoir container integrated into the automatic dishwasher and/or textile washing machine, i.e. a reservoir container fixedly connected to (built into) the automatic dishwasher and/or textile washing machine, but also an autonomous, i.e. independent reservoir container introducible into the interior of the automatic dishwasher and/or textile washing machine.

An example of an integrated reservoir container is a receiving container integrated into the door of the automatic dishwasher and/or textile washing machine, connected via a supply line to the interior of the automatic dishwasher and/or textile washing machine.

An example of an autonomous reservoir container is a so-called upside-down bottle, having a bottom-side outlet valve, that can be placed e.g. into the cutlery basket of the automatic dishwasher.

The reservoir container comprises at least one chamber for receiving the liquid cleaning-agent preparations according to the present invention. In a preferred embodiment, the reservoir container possesses more than one, by preference two, three, four or more separate receiving chambers separated from one another, of which at least one chamber contains the liquid cleaning-agent preparations according to the present invention while at least one, by preference at least two further chambers by preference contain(s) liquid preparations having a composition differing from the liquid cleaning-agent preparations according to the present invention.

In particular, those methods according to the present invention using a reservoir container having two separate receiving chambers separated from one another, of which one chamber contains a liquid cleaning-agent preparation according to the present invention while the second receiving chamber contains a likewise liquid, bleaching agent-free preparation of differing composition, are particularly preferred.

In preferred cleaning methods, a quantity of between 1.0 and 45 ml, by preference between 5.0 and 40 ml, and in particular between 7.0 and 35 ml of the liquid cleaning-agent preparation A according to the present invention is dispensed, for each cleaning cycle, into the interior of the automatic dishwasher and/or textile washing machine.

The volume of preferred reservoir containers having one or more receiving chambers is equal to between 10 and 1000 ml, by preference between 20 and 800 ml, and in particular between 50 and 500 ml.

As previously stated, the cleaning-agent preparations according to the present invention are notable for particular temperature stability, and the methods according to the present invention are used in particular for repeated dispensing of said preparations out of reservoir containers present in the interior of the automatic dishwasher and/or textile washing machine. Preferred methods according to the present invention are characterized in that the liquid cleaning-agent preparation A, before dispensing thereof into the interior of the automatic dishwasher and/or textile washing machine, remains in the reservoir container present in the automatic dishwasher and/or textile washing machine for the duration of at least two, by preference at least four, particularly preferably at least eight, and in particular at least twelve separate cleaning methods. The formulations 1 to 115a disclosed in the tables are particularly suitable for these methods.

A “separate cleaning method” refers, in the context of the present Application, to completed cleaning methods that, in addition to the main cleaning cycle, by preference furthermore encompass a pre-wash cycle and/or a rinse cycle and/or post-wash cycle, and that can be selected and initiated, for example, by means of the program switch of the automatic dishwasher and/or textile washing machine. The duration of these separate cleaning methods is by preference equal to at least 15 minutes, by preference between 20 and 360 minutes, preferably between 30 and 240 minutes.

The time span between two separate cleaning methods within which the liquid cleaning-agent preparation is dispensed into the interior of the automatic dishwasher is by preference equal to at least 20 minutes, in particular at least 60 minutes, particularly preferably at least 120 minutes.

The temperature stress on the liquid cleaning-agent preparations according to the present invention can fluctuate within wide limits in the course of the methods according to the present invention, the liquid cleaning-agent preparations being suitable in particular for those methods in which the liquid cleaning-agent preparation A in the reservoir container is heated at least twice, by preference at least four times, particularly preferably at least eight times, and in particular at least twelve times to temperatures above 30° C., by preference above 40° C., and particularly preferably above 50° C. Heating to temperatures above 60° C. and/or above 70° C., and/or heating of the liquid cleaning-agent preparation A twenty or thirty times, is of course also achievable according to the present invention.

The formulations 1 to 115a disclosed in the tables are particularly suitable for these methods.

In other words, the liquid cleaning-agent preparation A in the reservoir container is heated, by the washing bath surrounding said reservoir container, in each of the successively occurring separate cleaning methods. In preferred methods, the liquid cleaning-agent preparation A in the reservoir container cools, between the separate cleaning methods, to temperatures below 30° C., by preference below 26° C., and in particular below 22° C.

Automatic dishwashing methods according to the present invention using a cleaning-agent preparation A according to the present invention are characterized in that in the course of said methods, a sub-quantity a of the cleaning-agent preparation A present in a cartridge present in the interior of the automatic dishwasher and/or textile washing machine is dispensed from the cartridge into the interior of the automatic dishwasher and/or textile washing machine, a residual quantity of the cleaning agent present in the cartridge remaining in the cartridge until the end of the dishwashing method and/or textile washing method, wherein said residual quantity corresponds to at least twice, by preference at least four times, and in particular at least eight times the quantity of sub-quantity a.

The formulations 1 to 115a disclosed in the tables are particularly suitable for these methods.

Not only the cleaning agents according to the present invention, but also the cleaning-agent combinations or cleaning-agent presentation forms or cleaning-agent dispensing systems according to the present invention described previously, can of course be used in the dishwashing methods and/or textile washing methods according to the present invention.

A further subject of this Application is therefore an automatic dishwashing method and/or automatic textile washing method using a cleaning-agent combination according to the present invention comprising a cleaning agent A as well as a further cleaning agent B different from A, in the course of which method a sub-quantity a of the cleaning agent A present in a cartridge present in the interior of the automatic dishwasher and/or textile washing machine, as well as furthermore a sub-quantity b of the cleaning agent B present in the cartridge, are dispensed from the cartridge into the interior of the automatic dishwasher and/or textile washing machine, residual quantities of the cleaning agents A and B remaining in the cartridge until the end of the dishwashing method and/or textile washing method, and the residual quantity of cleaning agent A corresponding to at least twice, by preference at least four times, and in particular at least eight times the quantity of sub-quantity a, and the residual quantity of cleaning agent B corresponding to at least twice, by preference at least four times, and in particular at least eight times the quantity of sub-quantity b.

A further subject of this Application is an automatic dishwashing method and/or automatic textile washing method using a cleaning-agent combination according to the present invention comprising a cleaning agent A as well as a further cleaning agent B different from A and a third cleaning agent C different from A and B, in the course of which method a sub-quantity a of the cleaning agent A present in a cartridge present in the interior of the automatic dishwasher and/or textile washing machine, as well as furthermore a sub-quantity b of the cleaning agent B present in the cartridge, and additionally a sub-quantity c of the cleaning agent C present in the cartridge, are dispensed from the cartridge into the interior of the automatic dishwasher and/or textile washing machine, residual quantities of the cleaning agents A, B, and C remaining in the cartridge until the end of the dishwashing method and/or textile washing method, and the residual quantity of cleaning agent A corresponding to at least twice, by preference at least four times, and in particular at least eight times the quantity of sub-quantity a, the residual quantity of cleaning agent B corresponding to at least twice, by preference at least four times, and in particular at least eight times the quantity of sub-quantity b, and the residual quantity of cleaning agent C corresponding to at least twice, by preference at least four times, and in particular at least eight times the quantity of sub-quantity c.

If cleaning-agent combinations having two, three, or more different cleaning agents are used in the automatic dishwashing method and/or textile washing method according to the present invention, dispensing of the different cleaning agents then occurs preferably at different times in the cleaning cycle.

A further subject of this Application is therefore an automatic dishwashing method and/or automatic textile washing method using a cleaning agent according to the present invention or a cleaning-agent combination according to the present invention or a cleaning-agent presentation form according to the present invention or a cleaning-agent dispensing system according to the present invention, in the course of which (a) at a point in time t1, a sub-quantity a of the cleaning-agent preparation A according to the present invention present in a cartridge present in the interior of the automatic dishwasher and/or textile washing machine is dispensed from the cartridge into the interior of the automatic dishwasher and/or textile washing machine, a residual quantity of the cleaning agent present in the cartridge remaining in the cartridge until the end of the dishwashing method and/or textile washing method, said residual quantity corresponding to at least twice, by preference at least four times, and in particular at least eight times the quantity of sub-quantity a; and (b) at least one further point in time t2≠t1, a sub-quantity b of the cleaning-agent preparation B present in a second cartridge present in the interior of the automatic dishwasher and/or textile washing machine and different from the cleaning-agent preparation A according to the present invention is dispensed from the cartridge into the interior of the automatic dishwasher and/or textile washing machine, a residual quantity of the cleaning agent present in that cartridge remaining in the cartridge until the end of the dishwashing method and/or textile washing method, said residual quantity corresponding to at least twice, by preference at least four times, and in particular at least eight times the quantity of sub-quantity b.

The formulations 1 to 115a disclosed in the tables are particularly suitable for these methods.

This Application further claims an automatic dishwashing method and/or automatic textile washing method using a cleaning agent according to the present invention or a cleaning-agent combination according to the present invention or a cleaning-agent presentation form according to the present invention or a cleaning-agent dispensing system according to the present invention, in the course of which: (a) at a point in time t1, a sub-quantity a of the cleaning-agent preparation A according to the present invention present in a cartridge present in the interior of the automatic dishwasher and/or textile washing machine is dispensed from the cartridge into the interior of the automatic dishwasher and/or textile washing machine, a residual quantity of the cleaning agent present in the cartridge remaining in the cartridge until the end of the dishwashing method and/or textile washing method, said residual quantity corresponding to at least twice, by preference at least four times, and in particular at least eight times the quantity of sub-quantity a; (b) at least one further point in time t2≠t1, a sub-quantity b of the cleaning-agent preparation B, present in a second cartridge present in the interior of the automatic dishwasher and/or textile washing machine and different from the cleaning-agent preparation A according to the present invention, is dispensed from the cartridge into the interior of the automatic dishwasher and/or textile washing machine, a residual quantity of the cleaning agent B present in that cartridge remaining in the cartridge until the end of the dishwashing method and/or textile washing method, said residual quantity corresponding to at least twice, by preference at least four times, and in particular at least eight times the quantity of sub-quantity b; and (c) at least one further point in time t3 t2≠t1, a sub-quantity c of the cleaning-agent preparation C, present in a third cartridge present in the interior of the automatic dishwasher and/or textile washing machine and different from the cleaning-agent preparation A according to the present invention and from the cleaning-agent preparation B, is dispensed from the cartridge into the interior of the automatic dishwasher and/or textile washing machine, a residual quantity of the cleaning agent C present in that cartridge remaining in the cartridge until the end of the dishwashing method and/or textile washing method, said residual quantity corresponding to at least twice, by preference at least four times, and in particular at least eight times the quantity of sub-quantity c.

In preferred embodiments of the automatic dishwashing methods and automatic textile washing methods described above having time-offset dispensing of the cleaning-agent preparations A and B and/or A, B, and C, the point in time t2 is located at least 1 minute, by preference at least 2 minutes, and in particular between 3 and 20 minutes before or after the point in time t1.

The formulations 1 to 115a disclosed in the tables are particularly suitable for these methods.

### EXAMPLES

In order to demonstrate the improved physical and chemical stability of cleaning agents according to the present invention, the following two cleaning-agent formulations shown in TABLE 35 were prepared.

TABLE 35
CLEANING-AGENT FORMULATIONS

| | Formulation | Formulation |
|---|---|---|
| Ingredient (in wt. %) | E1 | V1 |
| Water | 42.7 | 40.1 |
| Polycarboxylate | 7.2 | 6.8 |
| Phosphonate | 3.0 | 2.9 |
| Nonionic surfactant | — | 5.7 |
| Sodium citrate | 13.0 | 12.3 |
| EDDS | 13.0 | 12.3 |
| KOH (47%) | 12.3 | 11.6 |
| Soda | 8.7 | 8.2 |
| Dye | 0.1 | 0.1 |
| Total | 100 | 100 |

The cleaning-agent formulations were manufactured by mixing and stirring the ingredients at 20° C. After manufacture, the formulations were heated to 75° C. After heating only a single time, clouding and sedimentation were observable in composition V1. Composition E1 remained stable with regard to sedimentation even after repeated heating to 75° C. and subsequent cooling to 20° C.

We claim:

1. A liquid alkaline cleaning-agent preparation for automatic dispensing in automatic dishwashing or automatic textile washing, said preparation comprising: (a) from 15 to 60 wt % builder; (b) from 30 to 80 wt % water; and (c) less than 5 wt % surfactant.

2. The cleaning-agent preparation of claim 1, wherein said builder includes at least one organic complexing agents.

3. The cleaning-agent preparation of claim 2, wherein said organic complexing agent is present from 17 to 50 wt % based on the total weight of the preparation.

4. The cleaning-agent preparation of claim 3, wherein said organic complexing agent is present from 23 to 40 wt % based on the total weight of the preparation.

5. The cleaning-agent preparation of claim 1 comprising from about 3.0 to 40 wt % ethylenediaminedisuccinic acid based on the total weight of the preparation.

6. The cleaning-agent preparation of claim 5, wherein said ethylenediaminedisuccinic acid is present from 10 to 20 wt %, based on the total weight of the preparation.

7. The cleaning-agent preparation of claim 1, wherein said builder includes at least one alkali carrier at from 1.0 to 30 wt % based on the total weight of the preparation.

8. The cleaning-agent preparation of claim 7, wherein said alkali carrier is present at from 5.0 to 20 wt %, based on the total weight of the preparation.

9. The cleaning-agent preparation of claim 1, wherein said builder includes at least one anionic polymer having cleaning activity, said polymer present at from 1.0 to 30 wt % based on the total weight of the preparation.

10. The cleaning-agent preparation of claim 9, wherein said polymer is present from 5.0 to 15 wt % based on the total weight of the preparation.

11. The cleaning-agent preparation of claim 1, wherein said water is present at from 35 to 75 wt % based on the total weight of the preparation.

12. The cleaning-agent preparation of claim 1, wherein said surfactant is present at less than 4 wt % based on the total weight of the preparation.

13. The cleaning-agent preparation of claim 12, wherein said preparation does not contain any surfactant.

14. A washing- or cleaning-agent combination comprising:
cleaning-agent preparation of claim 1; and
b) a separate cleaning-agent preparation comprising at least one enzyme having washing or cleaning activity.

15. A cleaning-agent combination comprising:
a) the cleaning-agent preparation of claim 1; and
b) a separate cleaning-agent preparation comprising at least one non-ionic surfactant and water.

16. Use of the liquid cleaning-agent preparation of claim 1 to fill:
a) a cartridge of a dispensing system integrated immovably in the interior of an automatic dishwasher or textile washing machine; or
b) a cartridge of a dispensing system provided for movable positioning in the interior of an automatic dishwasher or textile washing machine,
with a quantity of said liquid cleaning-agent preparation sufficient for carrying out an automatic dishwashing method or automatic textile washing method at least twice.

17. Use of the liquid cleaning-agent combination of claim 14 to fill:
a) a cartridge of a dispensing system integrated immovably in the interior of an automatic dishwasher or textile washing machine; or
b) a cartridge of a dispensing system provided for movable positioning in the interior of an automatic dishwasher or textile washing machine,
with a quantity of said liquid cleaning-agent combination sufficient for carrying out an automatic dishwashing method or automatic textile washing method at least twice.

18. Use of the liquid cleaning-agent combination of claim 15 to fill:
a) a cartridge of a dispensing system integrated immovably in the interior of an automatic dishwasher or textile washing machine; or
b) a cartridge of a dispensing system provided for movable positioning in the interior of an automatic dishwasher or textile washing machine,
with a quantity of said liquid cleaning-agent combination sufficient for carrying out an automatic dishwashing method or automatic textile washing method at least twice

19. A cleaning-agent presentation form comprising:
a) the liquid cleaning-agent preparation of claim 1 in a quantity sufficient for carrying out an automatic dishwashing method or automatic textile washing method at least twice; and
b) a cartridge for said cleaning-agent preparation.

20. Use of the cleaning-agent presentation form of claim 19 as a cleaning-agent reservoir for either: (a) a dispenser integrated immovably into the interior of an automatic dishwasher or textile washing machine; or (b) a movable dispenser provided for positioning in the interior of an automatic dishwasher or textile washing machine.

21. A cleaning-agent dispensing system comprising:
a) the liquid cleaning-agent preparation of claim 1 in a quantity sufficient for carrying out an automatic dishwashing method or automatic textile washing method at least twice;
b) a cartridge for said cleaning-agent preparation; and
c) a dispenser detachably connected to said cartridge.

22. Use of the cleaning-agent preparation of claim 1 for tableware cleaning in an automatic dishwashing method or for textile cleaning in an automatic textile washing method.

23. Use of the cleaning-agent combination of claim 14 for tableware cleaning in an automatic dishwashing method or for textile cleaning in an automatic textile washing method.

24. Use of the cleaning-agent presentation form of claim 19 for tableware cleaning in an automatic dishwashing method or for textile cleaning in an automatic textile washing method.

25. Use of the cleaning-agent dispensing system of claim 21 for tableware cleaning in an automatic dishwashing method or for textile cleaning in an automatic textile washing method.

26. An automatic dishwashing method or automatic textile washing method using the cleaning-agent combination of claim 14, in the course of which dispensation of a sub-quantity a of the cleaning-agent present in a reservoir container located in the interior of the automatic dishwasher or textile washing machine from the reservoir container into the interior of the automatic dishwasher or textile washing machine, with a residual quantity of the cleaning agent present in the reservoir container remaining in the reservoir container until the end of the dishwashing method or textile washing method, wherein said residual quantity corresponds to at least twice the quantity of sub-quantity a.
